(19) United States
(12) Patent Application Publication
(10) Pub. No.: US 2005/0268604 A1
(43) Pub. Date: Dec. 8, 2005

(54) Stirling cycle engine

(76) Inventors: Takashi Takahashi, Niigata-ken (JP); Hideto Urasawa, Niigata-ken (JP)

Correspondence Address: QUARLES & BRADY LLP, 411 E. WISCONSIN AVENUE, SUITE 2040, MILWAUKEE, WI, 53202-4497, US

(21) Appl. No.: 10/886,133

(22) Filed: Jul. 7, 2004

(30) Foreign Application Priority Data
Sep. 25, 2003 (JP) 2003-334275

(51) Int. Cl. F02G 1/04; F01B 29/10

(52) U.S. Cl. 60/517

(57) ABSTRACT

A Stirling cycle engine of a simplified structure, having enhanced reliability by improving abrasion resistance and lubricity of components thereof. When a piston reciprocates in a cylinder along the axial direction thereof by a driving mechanism, a displacer reciprocates in the cylinder along the axial direction thereof accompanying the reciprocation of the piston. The piston and the displacer slide in contact with the inner peripheral surface of the cylinder, but the piston and the displacer are each integrally made from an engineering plastic such as PPS having fine strength, dimensional stability, abrasion resistance and formability, while PPS is made CFRP. Moreover, solid lubricity agent is added to PPS. Accordingly, abrasion resistance, lubricity, strength and precision of the piston and displacer are enhanced, while the piston and the displacer can be simply produced by a well-known plastic molding.

### BACKGROUND OF THE INVENTION

1. Field of the Invention

The present invention relates to a Stirling cycle engine.

2. Description of the Related Art

An example of a conventional Stirling cycle engine is disclosed in Japanese Patent Unexamined Publication No. 2001-355513. The disclosed Stirling cycle engine has a piston and a displacer slidably inserted into a cylinder provided within a casing, the piston being reciprocated by a driving mechanism. When the piston is operated by the driving mechanism so that it travels in the cylinder and comes close to the displacer, a gas, which is in a compression chamber provided between the piston and the displacer, is compressed and flows into an expansion chamber provided between a distal end of the displacer and a distal portion of the casing, through a heat dissipating fin, a regenerator and a heat absorbing fin. Accordingly, the displacer is pushed downwardly with a predetermined phase difference relative to the piston. On the other hand, when the piston travels in the cylinder away from the displacer, the inside of the compression chamber is subjected to negative pressure, and the gas in the expansion chamber flows back to the compression chamber through the heat absorbing fin, the regenerator and the heat dissipating fin. Accordingly, the displacer is pressed upwardly with the predetermined phase difference relative to the piston. Throughout these processes, a reversible cycle consisting of two changes: an isothermal change; and an isovolumetric change is carried out, and thus a portion adjacent to the expansion chamber is brought into a low-temperature state and a portion adjacent to the compression chamber is brought into a high-temperature state.

As described, in the above-described Stirling cycle engine, the piston is reciprocated in the cylinder along the axial direction of the cylinder by the driving mechanism for operating the piston, while the displacer is reciprocated in the cylinder in conjunction with the piston along the axial direction of the cylinder. Since the piston and displacer move inside the cylinder, abrasion resistances and lubricities of the piston, displacer and cylinder are extremely important in this kind of the Stirling cycle engine. In the case of using lubricating oil in order to improve the abrasion resistance and lubricity thereof, the lubricating oil may fly in all directions within the Stirling cycle engine, so that the flied lubricating oil may cause the regenerator to be clogged therewith, and thus the flow of the gas is blocked. Accordingly, gas lubrication mechanisms have conventionally been formed on the surfaces of the piston and/or displacer, or coatings of PTFE (polytetrafluorethylene) having self-lubricities have been formed on the surfaces of the piston and/or displacer, or on the inner peripheral surface of the cylinder.

In the case of forming the gas lubrication mechanisms, however, since it is necessary to form gas-films by continuously blowing the gas inside the Stirling cycle engine to small clearances between the cylinder and the piston and/or displacer, the structures of the piston and/or displacer become complicated. Accordingly, a complicated processing is necessary, and thus not only the cost thereof would be increased, but also the reliability thereof would be jeopardized. Moreover, in the case of forming the PTFE coating, the PTFE on the surfaces may be abraded due to the movement of the piston and/or displacer in the cylinder even if it has self-lubricity, while the worn PTFE is liable to be reduced to powder and cause the regenerator to be clogged therewith.

### SUMMARY OF THE INVENTION

The present invention has been made to solve the above problems. It is, therefore, an object of the present invention to simplify a structure of a Stirling cycle engine so as to simplify the assembling thereof and to enhance the abrasion resistance and lubricity of a cylinder, displacer and piston so as to improve the reliability of the Stirling cycle engine.

In order to attain the above object, according to a first aspect of the present invention, there is provided a Stirling cycle engine comprising: a casing; a cylinder coaxially inserted into the casing; a displacer slidably inserted into the inside of a distal portion of the cylinder; a piston slidably inserted into the inside of a proximal portion of the cylinder; and a driving mechanism provided at an outer periphery of the proximal portion of the cylinder, the driving mechanism reciprocating the piston, wherein either an inner peripheral surface of the cylinder or (an) inner peripheral surface(s) of the piston and/or displacer is made from an engineering plastic having fine abrasion resistance, dimensional stability, mechanical strength and formability.

By employing the above-described structure, the cylinder, piston, displacer etc. can have necessary abrasion resistance, precision and strength. Accordingly, reliability, durability and effectiveness of the Stirling cycle engine can be enhanced. Further, those cylinder, piston, displacer and, etc. can be simply made by a well-known plastic molding.

In the above-mentioned Stirling cycle engine, the engineering plastic may comprise a fiber-reinforced plastic.

In the above-mentioned Stirling cycle engine, solid lubricity agent may be added to the engineering

In order to attain the above object, according to a second aspect of the present invention, there is provided a Stirling cycle engine comprising: a piston; a displacer; and a cylinder slidably including the piston and the displacer, wherein either an inner peripheral surface of the cylinder or an outer peripheral surface(s) of the piston and/or displacer is made from an engineering plastic having fine abrasion resistance, dimensional stability, mechanical strength and formability.

By employing the above-described structure, the cylinder, piston, displacer etc. can have necessary abrasion resistance, precision and strength. Accordingly, reliability, durability and effectiveness of the Stirling cycle engine can be enhanced. Further, those cylinder, piston, displacer, etc. can be simply made by a well-known plastic molding.

Alternatively, the engineering plastic may comprise a fiber-reinforced plastic.

Further, solid lubricity agent may be added to the engineering plastic.

In order to attain the above object, according to a third aspect of the present invention, there is provided a Stirling cycle engine comprising: a piston; a displacer; and a cylinder slidably including the piston and the displacer, a piston ring(s) attached to an outer surface(s) of the piston and/or the displacer, wherein either an inner peripheral surface of the cylinder or the piston ring is made from an engineering plastic having fine abrasion resistance, dimensional stability, mechanical strength and formability.

By employing the above-described structure, the cylinder or the piston ring(s) can have necessary abrasion resistance, precision and strength. Accordingly, reliability, durability and effectiveness of the Stirling cycle engine can be enhanced. Further, the cylinder or the piston rings can be simply made by a well-known plastic molding.

In the above-described Stirling cycle engine, the engineering plastic may comprise a fiber-reinforced plastic.

Moreover, solid lubricity agent may be added to the engineering plastic.

In order to attain the above object, according to a fourth embodiment of the present invention, there is provided a Stirling cycle engine comprising: a cylinder; a displacer slidably inserted into the inside of a distal portion of the cylinder; a piston slidably inserted into the inside of a proximal portion of the cylinder, the piston having a through-hole along an axis of the piston; and a displacer rod inserted into the through-hole, one end of the displacer rod connected to the displacer so as to limit a reciprocation movement of the displacer, wherein either an inner surface of the through-hole or an outer peripheral surface of the displacer rod is made from an engineering plastic having fine abrasion resistance, dimensional stability, mechanical strength and formability.

By employing the above-described structure, the piston or the displacer rod can have necessary abrasion resistance, precision and strength. Accordingly, reliability, durability and effectiveness of the Stirling cycle engine can be enhanced. Further, the piston, displacer rod, etc. can be simply made by a well-known plastic molding.

In the above-described Stirling cycle engine, the engineering plastic may comprise a fiber-reinforced plastic.

Moreover, solid lubricity agent may be added to the engineering plastic.

In order to attain the above object, according to a fifth aspect of the present invention, there is provided a Stirling cycle engine comprising: a cylinder; a displacer slidably inserted into the inside of a distal portion of the cylinder; a piston slidably inserted into the inside of a proximal portion of the cylinder, the piston having a through-hole along an axis of the piston; at least a sliding-contacting means inserted into the through-hole; and a displacer rod inserted into the sliding-contacting means in the through-hole, one end of the displacer rod connected to the displacer so as to limit a reciprocation movement of the displacer, wherein either the sliding-contacting means or an outer peripheral surface of the displacer rod is made from an engineering plastic having fine abrasion resistance, dimensional stability, mechanical strength and formability.

By employing the above-described structure, the sliding-contacting means or the displacer rod can have necessary abrasion resistance, precision and strength. Accordingly, reliability, durability and effectiveness of the Stirling cycle engine can be enhanced. Further, the sliding-contacting means or the displacer rod can be simply made by a well-known plastic molding.

Alternatively, in the Stirling cycle engine employing the above-structures, the engineering plastic may comprise a fiber-reinforced plastic.

Further, solid lubricity agent may be added to the engineering plastic.

### BRIEF DESCRIPTION OF THE DRAWINGS

These objects and other objects and advantages of the present invention will become more apparent upon reading of the following detailed description and the accompanying drawings in which:

FIG. 1 is a cross sectional view entirely showing a Stirling cycle engine according to a first embodiment of the present invention;

FIG. 2 is a cross sectional view showing a part of a piston of a Stirling cycle engine according to a second embodiment; and

FIG. 3 is a cross sectional view showing a part of a piston of a Stirling cycle engine according to a third embodiment.

### DETAILED DESCRIPTION OF THE PREFERRED EMBODIMENTS

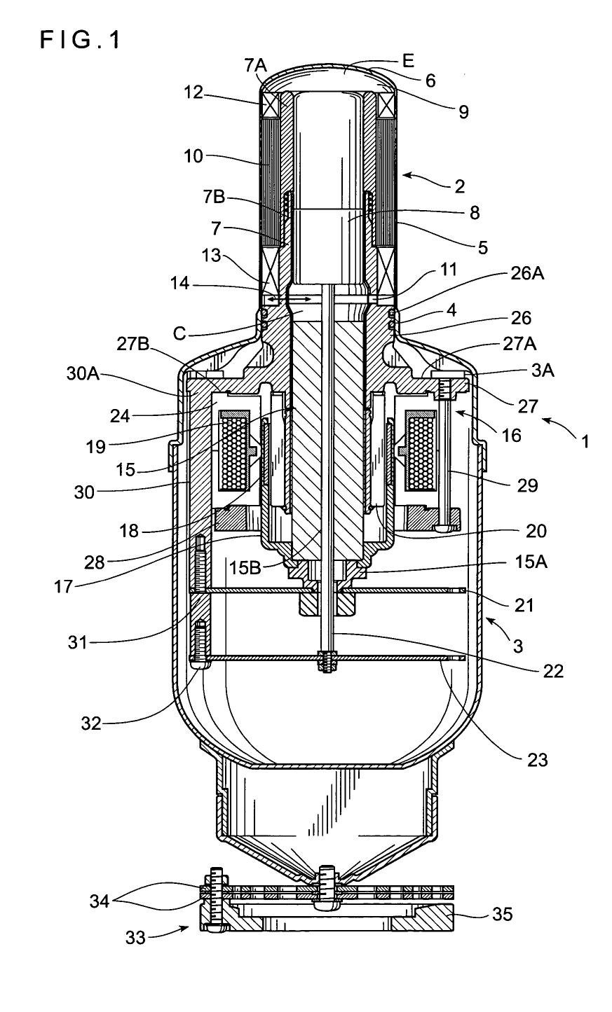

Preferred embodiments of the present invention will now be described in detail with reference to the accompanying drawings, taking a free-piston type Stirling cooler as an example of a Stirling cycle engine. In the following description, which is top and which is bottom goes by a posturing shown in FIG. 1.

### First Embodiment

In FIG. 1, reference number 1 denotes a casing which comprises: a cylindrical portion 2 formed in a substantially cylindrical shape; and a main body portion 3 also formed in a substantially cylindrical shape. The cylindrical portion 2 is made from, for example, stainless steel and comprises a proximal portion 4, an intermediate portion 5 and a distal portion 6, while these three portions are integrated with one another.

Inside the cylindrical portion 2, a cylinder 7 extending to the inside of the main body portion 3 is coaxially inserted. An extended cylinder portion 7A which is a discrete portion from the cylinder 7 is coaxially connected to the distal end of the cylinder 7 adjacent to the distal portion 6. The cylinder 7 locating adjacent to the main body portion 3 is integrally formed with mounts 26, 27 (described later) and a plurality of connecting arms 30 (also described later) by casting such as die casting, using a metallic material such as aluminum, and the inner and the outer peripheries thereof are formed by cutting after casting. A displacer 8 is slidably accommodated inside the distal part of the cylinder 7 and that of the extended cylinder portion 7A so as to slide along the axial direction thereof. An expansion chamber E is provided between the distal end of the displacer 8 and the distal portion 6 of the cylindrical portion 2, while the inside and outside of the extended cylinder portion 7A are communicated with each other via an aperture 9. In the intermediate portion 5, a regenerator 10 is provided between the inner periphery of the cylindrical portion 2 and the outer periphery of the cylinder 7. In the proximal portion 4, a communication hole 11 for allowing the inside of the cylinder 7 to communicate with the outside thereof is formed on the cylinder 7. A heat absorbing fin 12 is provided between the inner periphery of the distal portion 6 included in the cylindrical portion 2 and the outer periphery of the distal end of the extended cylinder portion 7A, while a heat dissipating fin 13 is provided between the inner periphery of the cylindrical portion 2 and the outer periphery of the cylinder 7 in between the regenerator 10 and the communication hole 11. A path 14 is formed so as to connect the distal end of the inside of the extended cylinder portion 7A to the compression chamber C provided inside the cylinder 7 through the aperture 9, the heat absorbing fin 12, the regenerator 10, the heat dissipating fin 13 and the communication hole 11. Moreover, in the main body portion 3, a piston 15 is slidably accommodated inside the proximal side of the cylinder 7 in a manner capable of sliding in the axial direction of the cylinder 7. A proximal portion of the piston 15 is coaxially connected to a driving mechanism 16. The driving mechanism 16 comprises: a short-cylindrical supporting member 17 connected to the proximal portion of the piston 15 via a connecting member 15A and coaxially provided on the outer periphery of the proximal side of the cylinder 7; a permanent magnet 18 formed in a short-cylindrical shape and fixed to the inner peripheral surface of the distal portion of the supporting member 17; an annular electromagnetic coil 19 provided adjacent to the outer periphery of the permanent magnet 18; and a magnetism introducing portion 20 provided adjacent to the inner periphery of the permanent magnet 18. Further, a rod through-hole 15B is coaxially formed on the piston 15, while a rod 22 (described later) is inserted into the rod through-hole 15B.

A smoothed coating layer 7B is formed on the inner peripheral surface of the cylinder 7 by electroless plating of chromated zinc, nickel or the like to enhance hardness of the inner surface and to improve abrasion resistance thereof, Correspondingly, the piston 15 and displacer 8 are made from PPS (polyphenylene sulfide) so as to be integrated with each other, wherein PPS is an engineering plastic having fine abrasion resistance, dimensional stability, mechanical strength and formability. Meanwhile, PPS forming the piston 15 and displacer 8 becomes CFRP (Carbon Fiber Reinforced Plastic) when discontinuous fibers of carbon are mixed therein, so that its dimensional stability, mechanical strength and abrasion resistance is further improved. Moreover, lubricity is added by adding solid lubricity agent such as molybdenum disulfide, PTFE or the like. The piston 15 and the displacer 8 can be made by a well-known plastic molding technique.

To the connecting member 15A for connecting the piston 15 to the supporting member 17, a first flat spring 21 for controlling the operation of the piston 15 is attached. Moreover, to the proximal side of the displacer 8, one end of the rod 22 (displacer rod) is connected for controlling the operation of the displacer 8, while the other end thereof is connected to a second flat spring 23. The rod 22 extends in a manner that it penetrates the piston 15 throughout the rod through-hole 15B. The rod 22 is made of, for example, relatively rigid stainless steel. As illustrated, a pair of the flat springs 21, 23 is placed outside the proximal part of the cylinder 7 in the main body portion 3, while the second flat spring 23 is placed in a position away from the proximal part of the cylinder 7 compared to a position where the first flat spring 21 is placed. Meanwhile, the electromagnetic coil 19 is wound around an electromagnetic core 24, while the electromagnetic core 24 is integrated with the electromagnetic coil 19.

At the outer peripheral surface of the intermediate part of the cylinder 7, the mount 26 coaxially protruding along with the cylinder 7 is integrally formed, while at a position more closer to the proximal end of the cylinder 7 compared to the position where the mount 26 is placed, the flange-type mount 27 is integrally formed on the cylinder 7. The pair of mounts 26, 27 is placed so as to have a predetermined interval, while the mount 26 contacts the proximal portion 4 of the cylindrical portion 2 via O-rings 26A and fixes the cylinder 7 to the cylindrical portion 2 of the casing 1. The mount 27 employs a structure such that one side surface 27A thereof contacts a mount portion 3A locating the inside of the main body portion 3. The mount 27 is fixed to the mount portion 3A by at least one screw, while the other side surface 27B thereof contacts one end of the electromagnetic core 24 comprising the driving mechanism 16. The other end of the electromagnetic core 24 contacts a fixation ring 28. For supporting the electromagnetic core 24, the mount 27 and the fixation ring 28 sandwiches it while a screw 29 fastens them. Accordingly, the electromagnetic core 24 and the electromagnetic coil 19 integrated with it are mounted onto the mount 27. Moreover, at the other side surface 27B of the mount 27, the plurality of connecting arms 30 are provided so as to protrude from the other side surface 27B along the axial direction of the cylinder 7. As illustrated, the connecting arms 30 are integrally formed with the mount 27 via proximal portions 30A thereof. The first flat spring 21 is attached to the distal portions of the connecting arms 30 via spacers 31, while the second flat spring 23 is attached to the spacers 31 by screws 32.

Meanwhile, reference number 33 denotes a vibration absorbing unit provided at the other end of the casing 1, while the vibration absorbing unit 33 comprises plural flat springs 34 and a balancing weight 35. The plural blade springs 34 and the balancing weight 35 coaxially stack on with each other through a connecting portion arranged on the axial line of the cylinder 7.

The cylinder 7 is thus fixed to the casing 1 by allowing: the mount 26 to contact the inside of the proximal portion 4 included in the cylindrical portion 2 via the O-ring 26A; the one side surface 27A of the mount 27 to contact the mount portion 3A in the main body portion 3; and the mount 27 to be screwed on the mount portion 3A via an non-illustrated screw. Since the mount 26 contacts the inner surface of the cylindrical portion 2 via the O-ring 26A, the cylinder 7 can be coaxially arranged relative to the cylindrical portion 2. The cylinder 7 allows the magnetism introducing portion 20 to be attached to the outer periphery of the proximal end thereof, while it also allows the electromagnetic coil 19 and the electromagnetic core 24 both included in the driving mechanism 16 to be fixed to the mount 27 integrally formed on the cylinder 7 by the fixation ring 28 and the screw 29. The displacer 8 and the piston 15 or the like are installed in the cylinder 7, the first flat spring 21 attached to the connecting member 15A adjacent to the proximal portion of the piston 15 is sandwiched and supported between the connecting arms 30 and the spacers 31, while the second flat spring 23 in which the center part is connected to the other end of the rod 22 connected to the displacer 8 is fixed to the other ends of the spacers 31. The main body portion 3 and the cylindrical portion 2 are connected to each other, while the vibration absorbing unit 33 pre-assembled is then attached to the main body portion 3.

In the Stirling cycle engine employing the above-described structure, when an alternate current is applied to the electromagnetic coil 19, an alternate magnetic field is generated from the electromagnetic coil 19 and concentrated around the electromagnetic core 24. A force for allowing the permanent magnet 18 to reciprocate along the axial direction of the cylinder 7 is then generated by the generated alternate magnetic field. Due to this force, the piston 15 connected to the supporting member 17 supporting the permanent magnet 18 starts reciprocating in the cylinder 7 along the axial direction of the cylinder 7. When the piston 15 travels toward the displacer 8, a gas in a compression chamber C locating in between the displacer 8 and the piston 15 is compressed. The compressed gas then flows into the expansion chamber E locating in between the distal end of the displacer 8 and the distal portion 6 of the cylindrical portion 2, through the communication hole 11, the heat dissipating fin 13, the regenerator 10, the heat absorbing fin 12 and the aperture 9, and thus the displacer 8 is pressed downwardly with a predetermined phase difference relative to the piston 15. On the other hand, when the piston 15 travels away from the displacer 8, the inside of the compression chamber C is subjected to negative pressure and the gas in the expansion chamber E flows back to the compression chamber C through the aperture 9, the heat absorbing fin 12, the regenerator 10, the heat dissipating fin 13 and the communication hole 11, and thus the displacer 8 is pressed upwardly with the predetermined phase difference relative to the piston 15. Throughout these processes, a reversible cycle consisting of two changes: an isothermal change; and an isovolumetric change is carried out, thus the adjacent part of the expansion chamber E is brought into a low-temperature state, while the compression chamber C is brought into a high-temperature state.

The force for allowing the permanent magnet 18 to reciprocate along the axial direction of the cylinder 7 is generated by the alternate magnetic field generated from the electromagnetic coil 19 of the driving mechanism 16, and thus the piston 15 connected to the supporting member 17 supporting the permanent magnet 18 reciprocates in the cylinder 7 along the axial direction thereof due to the force, while the displacer 8 reciprocates in conjunction with the reciprocation of the piston 15 with the predetermined phase difference relative to the piston 15. The piston 15 and the displacer 8 contact the inner peripheral surface of the cylinder 7 and slide across the inner peripheral surface thereof, while the rod 22 slides in contact with the inner surface of the rod through-hole 15B of the piston 15 at the same time. However, the abrasion of the piston 15, displacer 8, cylinder 7 and rod 22 can be considerably prevented since: the abrasion resistance of the inner peripheral surface of the cylinder 7 working as a sliding surface for the piston 15 and displacer 8 is enhanced by the coating layer 7B having fine abrasion resistance, formed on the inner peripheral surface of the cylinder 7; the abrasion resistance of the rod 22 is enhanced because it is made from relatively rigid stainless steel; and the piston 15 and the displacer 8 are made from PPS so as to be integrated with each other, PPS having fine abrasion resistance. Moreover, since the piston 15 and the displacer 8 are made from PPS having fine mechanical strength and dimensional stability, a possibility that the piston 15 and the displacer 8 will be broken can be minimized, while the possibility that the piston 15 and the displacer 8 will be immobilized in the cylinder 7 due to the piston 15 and the displacer 8 thermally expanding and clinging to the inner peripheral surface of the cylinder 7, can also be minimized. Conversely, even if the gap is made further smaller, yet the possibility of the piston 15 and the displacer 8 clinging to the inner peripheral surface of the cylinder 7 and being immobilized therein due to the thermal expansion thereof can be minimized, and thus the gap can be safely made further smaller so that the amount of a gas leaking from a gap between the piston 15/the displacer 8 and the cylinder 7 can be reduced, thus enhancing the effectiveness of the Stirling cycle. Further, by allowing PPS to be CFRP and allowing solid lubricity agent such as molybdenum disulfide, PTFE or the like to be added, strength, precision and abrasion resistance of the piston 15 and the displacer 8 are further improved, while lubricity thereof also is added. Accordingly, abrasion of the portions where the sliding between the piston 15/the displacer 8 and the cylinder 7 occur can be further suppressed, as well as abrasion of the portion where the sliding between the rod 22 and the rod through-hole 15B of the piston 15 occur can also be further suppressed, while ensuring the improvement of lubricities thereof. Therefore, the reliability and durability of the cylinder 7, piston 15 and displacer 8 can be enhanced. Further, by employing a structure such that the piston 15 and the displacer 8 made from PPS and integrated with each other are incorporated into the cylinder 7 in which the coating layer 7B is formed on the inner peripheral surface thereof by electroless plating, the structures of the cylinder 7, piston 15 and displacer 8 can be simplified compared to the conventional ones, and thus a forming process of the Stirling cycle engine can be simplified. Besides, since a gas lubrication mechanism or the like is not necessary, the number of assembled parts can be decreased, and thus the assembling workability of the Stirling cycle engine can be improved. Still further, the piston 15 and the displacer 8 can be easily made by a well-known plastic molding technique.

Meanwhile, whilst the piston 15 and the displacer 8 are made from PPS and integrated with each other in the above embodiment, the cylinder 7 may be made from PPS, and/or the surface of the rod 22 may be coated with PPS.

### Second Embodiment

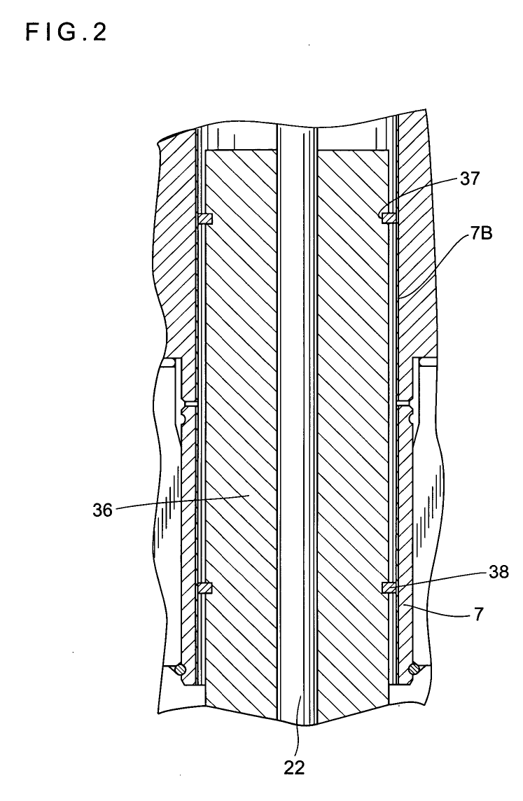

Next, a second embodiment of the present invention will now be described. FIG. 2 is a cross sectional view showing a part of a piston of a Stirling cycle engine according to the second embodiment. Meanwhile, the Stirling cycle engine of this embodiment employs the same structure as that of the first embodiment except a piston 36, and thus the same reference numbers will denote the same structural portions, and detailed explanations thereof will be omitted. In this embodiment, two grooves 37 are formed along the outer periphery of the piston 36 on the outer surface thereof, while piston rings 38 made from PPS are fitted in the grooves 37, and thus the piston rings 38 slide on the inner peripheral surface of the cylinder 7 when the piston 36 reciprocates. As with the first embodiment, PPS is an engineering plastic having fine mechanical strength and formability, accordingly dimensional stability, mechanical strength and abrasion resistance are further added by mixing discontinuous fibers of carbon, while lubricity is added by adding solid lubricity agent such as molybdenum disulfide, PTFE or the like.

According to this embodiment, the piston 36 does not directly contact the inner peripheral surface of the cylinder 7 when reciprocates, and thus the piston 36 itself does not abrade. Accordingly, only the piston rings 38 may be replaced in a regular maintenance and replacement thereof is simple, and thus the maintenance cost would be inexpensive. Further, the piston rings 38 are easy to form, do not easily deform or abrade, and has excellent durability since those are made from PPS. Still further, the abrasion of the inner peripheral surface of the cylinder 7 can be decreased due to the lubricity of the piston rings 38, and thus the durability of the cylinder 7 can be improved.

Whilst the grooves 37 are formed on the outer surface of the piston 36 and the piston rings 38 are fitted to the grooves 37 in this embodiment, forming the grooves 37 is not necessarily required. The piston rings 38 may be fitted without forming the grooves 37. Moreover, the piston rings 38 may be fitted to the outer surface of the displacer 8. Alternatively, whilst the piston rings 38 are made from PPS in this embodiment, the cylinder 7 may be made from PPS instead.

### Third Embodiment

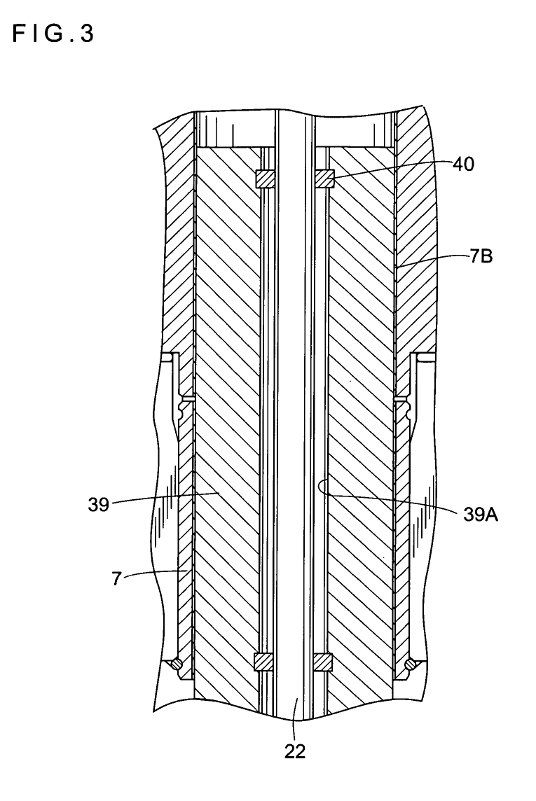

Next, a third embodiment of the present invention will now be described. FIG. 3 is a cross sectional view showing a part of a piston of a Stirling cycle engine according to the third embodiment. Meanwhile, the Stirling cycle engine of this embodiment employs the same structure as that of the first embodiment except a piston 39, and thus the same reference numbers will denote the same structural portions, and detailed explanations thereof will be omitted. In this embodiment, two sleeves 40 (sliding-contacting means) are passed through a rod-through-hole 39A of a piston 39, while the sleeves 40 and the rod 22 are to slide. The sleeves 40 are made from PPS, an engineering plastic having fine mechanical strength and formability, to which are added dimensional stability, mechanical strength and abrasion resistance by mixing discontinuous fibers of carbon, while lubricity is added by adding solid lubricity agent such as molybdenum disulfide, PTFE or the like.

According to this embodiment, the piston 39 itself does not abrade when the piston 39 and the rod 22 relatively move, since the inner surface of the rod through-hole 39A of the piston 39 does not directly contact the rod 22, and thus only the sleeves 40 may be replaced when maintenance thereof is carried out. Accordingly, maintenance cost would be inexpensive. Moreover, since each sleeve 40 is made from PPS, it has less abrasion, fine dimensional stability, mechanical strength and high lubricity. Accordingly, the stable movement thereof can be assured over a long period of time, while the durability can be improved. Further, since each sleeves 40 itself has high lubricity, the abrasion of the rod 22 sliding with the sleeves 40 can be decreased, and thus the durability of the rod 22 can be improved.

Alternatively, whilst the sleeves 40 are made from PPS in the foregoing embodiment, the outer peripheral surface of the rod 22 may be coated with PPS instead.

Various embodiments and changes may be made thereonto without departing from the broad spirit and scope of the invention. The above-described embodiments are intended to illustrate the present invention, not to limit the scope of the present invention. For example, PPS is used as an engineering plastic having fine abrasion resistance, dimensional stability, mechanical strength and formability in the above-described embodiments, but other kinds of engineering plastics such as POM (polyoxymethylene), PEEK (Poly Ether Ether Ketone, registered trademark) may be used. Moreover, discontinuous fibers of carbon are mixed in the engineering plastic satisfying the above-described conditions in the above-described embodiments so as to form CFRP, but discontinuous fibers of glass may be mixed so as to form GFRP (Glass Fiber Reinforced Plastic). Further, whilst the free-piston type reverse Stirling cycle Stirling cooler is taken as an example of the Stirling cycle engine in the above-described embodiments, the present invention may be applied to other kinds or types of Stirling cycle engine, such as non free-piston type Stirling cooler, Stirling engine using the Stirling cycle, or the like.

1. A Stirling cycle engine comprising:
a casing;
a cylinder coaxially inserted into said casing;
a displacer slidably inserted into the inside of a distal portion of said cylinder;
a piston slidably inserted into the inside of a proximal portion of said cylinder; and
a driving mechanism provided at an outer periphery of the proximal portion of said cylinder, said driving mechanism reciprocating said piston,
wherein at least one of said piston and said displacer are each integrally made from an engineering plastic having fine abrasion resistance, dimensional stability, mechanical strength and formability.

2. The Stirling cycle engine according to claim 1, wherein said engineering plastic is a fiber-reinforced plastic.

3. The Stirling cycle engine according to claim 1, wherein solid lubricity agent is added to the engineering plastic.

4. A Stirling cycle engine comprising:
a piston;
a displacer; and
a cylinder slidably including said piston and said displacer,
wherein at least one of said piston and said displacer are each integrally made from an engineering plastic having fine abrasion resistance, dimensional stability, mechanical strength and formability.

5. The Stirling cycle engine according to claim 4, wherein said engineering plastic is a fiber-reinforced plastic.

6. The Stirling cycle engine according to claim 4, wherein a solid lubricity agent is added to the engineering plastic.

7-15. (canceled)
